(19) United States
(12) Patent Application Publication
(10) Pub. No.: US 2025/0384581 A1
(43) Pub. Date: Dec. 18, 2025

(54) NEURAL RADIANCE FIELDS WITH UNPOSED IMAGES USING GEOMETRIC CONSISTENCY

(71) Applicant: Google LLC, Mountain View, CA (US)

(72) Inventors: Mark Jeffrey Matthews, Los Angeles, CA (US); Yuhe Jin, Vancouver (CA); Matan Sela, Sunnyvale, CA (US); Andrea Tagliasacchi, Burnaby (CA); Dmitry Lagun, San Jose, CA (US)

(21) Appl. No.: 19/241,359

(22) Filed: Jun. 17, 2025

Related U.S. Application Data
(60) Provisional application No. 63/660,992, filed on Jun. 17, 2024.

(51) Int. Cl. G06T 7/73

(52) U.S. Cl. CPC G06T 7/74; G06T 2207/20081; G06T 2207/20084

(57) ABSTRACT

Methods, systems, and apparatus, including computer programs encoded on a computer storage medium, for training a neural radiance field (NeRF) model on unposed images. In particular, the training incorporates a geometric consistency loss to train the encoder neural network that predicts the poses of the unposed images.

### CROSS-REFERENCE TO RELATED APPLICATIONS

This application claims the benefit of U.S. Provisional Application No. 63/660,992, filed Jun. 17, 2024, which is incorporated herein by reference.

### BACKGROUND

This specification relates to synthesizing images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that synthesizes images of a scene in an environment.

Throughout this specification, a “scene” can refer to, e.g., a real-world environment, or a simulated environment (e.g., a simulation of real-world environment, e.g., such that the simulated environment is a synthetic representation of a real-world scene).

In particular, the system trains a Neural radiance field (NeRF) model from a set of unposed images, i.e., a set of images for which camera pose information is not available, of a scene. To account for the images being unposed, the system trains the NeRF model jointly with a pose encoder neural network that predicts the pose of the images.

The system can then use the trained NeRF model to synthesize images of the scene from new viewpoints.

The subject matter described in this specification can be implemented in particular embodiments so as to realize one or more of the following advantages.

Neural radiance fields enable novel-view synthesis and scene reconstruction with photorealistic quality from a few images, but require known and accurate camera poses for the images used for training. Conventional pose estimation algorithms fail on smooth or self-similar scenes, while methods performing inverse rendering from unposed views require a rough initialization of the camera orientations. Thus, conventional approaches for combining pose estimation with a NeRF model fail to generate high quality and accurate images of a scene.

The main difficulty of pose estimation lies in real-life objects being almost invariant under certain transformations, making the photometric distance between rendered views non-convex with respect to the camera parameters. By using an equivalence relation that matches the distribution of local minima in camera space, this specification reduces pose estimation into a more convex problem and effectively incorporates an encoder neural network that performs pose estimation into the training of the NeRF model. The resulting technique can reconstruct a neural radiance field from unposed images with state-of-the-art accuracy while requiring ten times fewer views than adversarial approaches. Thus, the resulting NeRF model can be used to generate higher quality images after training and requires less data to train than conventional approaches.

However, the above techniques rely solely on the implicit regularization of poses provided by the architecture of the encoder neural network, e.g., on the regularization provided by a convolutional neural network architecture, which can be insufficient for the complexities of some real-world scenes. This limits the applicability of techniques that train the encoder solely by backpropagating gradients of the reconstruction objective.

To account for this, the system incorporates a geometric consistency loss, e.g., a loss that penalizes deviations from epipolar geometry, into the training of the encoder neural network. The incorporation of this loss allows the training of the NeRF model to converge on a wider range of scenes, including complex real-world scenes, greatly increasing the applicability of the system.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a block diagram of an example image rendering system.

FIG. 2A is a flow diagram of an example process for training a NeRF model on unposed images.

FIG. 2B shows an example of the operation of the system during training.

FIG. 3 is a flow diagram of an example process for performing a training step.

FIG. 4 is a flow diagram of an example process for training the encoder neural network using a consistency loss.

FIG. 5 shows an example of the performance of the described techniques.

Like reference numbers and designations in the various drawings indicate like elements.

### DETAILED DESCRIPTION

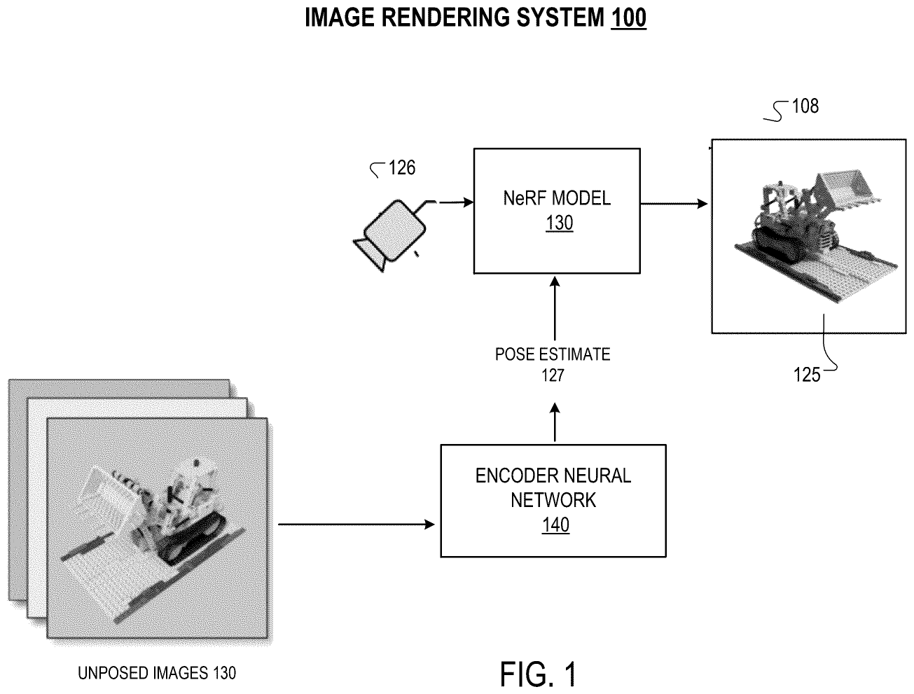

FIG. 1 is a block diagram of an example image rendering system 100 that can render (“synthesize”) a new image 108 that depicts a scene 125 in an environment from a perspective of a camera at a new camera pose 126 in the environment.

More generally, the image rendering system 100 is an example of a system implemented as computer programs on one or more computers in one or more locations in which the systems, components, and techniques described below are implemented.

An “image” can generally be represented, e.g., as an array of “pixels,” where each pixel is associated with a respective point in the image (i.e. with a respective point in the image plane of the camera) and corresponds to a respective vector of one or more numerical values representing image data at the point. For example, a two-dimensional (2D) RGB image can be represented by a 2D array of pixels, where each pixel is associated with a respective three-dimensional (3D) vector of values representing the intensity of red, green, and blue color at the point corresponding to the pixel in the image.

Throughout this specification, a “scene” can refer to, e.g., a region of a real-world environment or a region of a simulated environment.

A camera “pose” can refer to, e.g., a location and/or an orientation of the camera within the scene 125. A location of a camera can be represented, e.g., as a three-dimensional vector indicating the spatial position of the camera. The orientation of the camera can be represented as, e.g., a three-dimensional vector defining a direction in which the camera is oriented, e.g., the yaw, pitch, and roll of the camera.

In particular, the system 100 trains a Neural radiance field (NeRF) model 120 from a set of unposed images 130, i.e., a set of images for which camera pose information is not available, of the scene 125.

Generally, NeRF models represent radiance with a neural field that reproduces the geometric structure and appearance of a scene, allowing the use of backpropagation to reconstruct a set of input images.

More specifically, a NeRF model includes one or more neural networks that generate as output the values required to compute RGB or other color values C for each pixel p in an output image from samples taken points r along a ray of direction d. The ray direction is determined using the pixel location and the camera pose R 126.

Generally, the system can use any of a variety of NeRF model variants as the NeRF model 120. One example of a NeRF model variant is described in more detail below.

Thus, a NeRF model 120 takes as input a camera pose 126 and generates, using the one or more neural networks, as output a synthetic image 108 of the scene 125 that appears as if the image 108 was taken by a camera having the input camera pose 126.

During training, the synthetic images generated by the NeRF model 120 are reconstructions of the images in the set of training images. That is, the system 100 trains the NeRF model 120 to reconstruct the images in the set of training images.

After the NeRF model has been trained, the NeRF model 120 can receive as input a new camera pose 108 and generate a new synthetic image 108 of the scene 125 that appears as if the image has been taken by a camera having the new camera pose 126.

That is, the system 100 can use the trained NeRF model 120 to synthesize images of a scene from novel viewpoints that are not captured in the training set.

Conventionally, because the NeRF model 120 takes in as input camera poses, training the NeRF model 120 requires posed training images, i.e., training images that have associated camera poses, in order to render reconstruction images for use in evaluating the training loss. However, in many situations, posed training images may not be available. That is, the system 100 may have access to a set of images of a scene but may not have access to “ground truth” or “actual” camera poses for the camera(s) that captured the images.

To account for this, and to allow the system 100 to train the NeRF model 120 on the unposed training images 130, the system 100 makes use of an encoder neural network 140.

The encoder neural network 140 is a neural network that is configured to receive an input image and generate, as output, a pose estimate that estimates a camera pose of a camera that captured the input image.

The pose estimate can characterize the pose of the camera in any of a variety of ways.

For example, the pose estimate can include an estimated location of an origin in a camera reference frame of the camera. As a particular example, the pose estimate can include an estimated radial distance from the origin, i.e., represented as a scalar distance value.

As another example, the pose estimate can include an estimated azimuth of the camera. For example, the azimuth can be represented as an angle between 0 degrees and 360 degrees or between 0 and 2π radians.

As another example, the pose estimate can include an estimated elevation of the camera. For example, the elevation can be selected from a specified range, e.g., between-π/2 and +π/2, inclusive.

As yet another example, the pose estimate can include an estimated camera roll of the camera. For example, the camera roll of the camera can be represented as an angle between 0 degrees and 360 degrees or between 0 and 2π radians.

As yet another example, the pose estimate can include an estimated in-plane offset of the camera. For example, the in-plane offset can be represented as a pair of (x, y) coordinates.

As a particular example, in some cases the system can represent the camera pose as a combination of azimuth, elevation, and roll values. For example, this can be an accurate representation if the camera is assumed to always point toward an origin of a scene, e.g., a center of a particular object in the scene, from a known distance. That is, if the origin location is assumed to be known and the distance from the origin is assumed to be fixed, the system can accurately represent the pose by predicting only the azimuth, elevation, and roll.

As another particular example, in some other cases the system can represent the camera pose as a combination of azimuth, elevation, radial distance from the origin, and in-plane offset.

The encoder neural network 140 can generally have any appropriate architecture that allows the encoder neural network 140 to map input images, i.e., to map the intensity values of the pixels of the input images, to corresponding pose estimates.

For example, the encoder neural network 140 can be a convolutional neural network.

As another example, the encoder neural network 140 can be a vision Transformer (ViT) neural network.

More specifically, the system 100 trains the encoder neural network 140 jointly with the NeRF model 120. In particular, the system 100 trains the encoder neural network 140 using both the reconstruction loss used to train the NeRF model 120 and a geometric consistency loss, e.g., a loss that penalizes deviations from epipolar geometry. The incorporation of this consistency loss allows the training of the NeRF model 120 to converge on a wider range of scenes, including complex real-world scenes, greatly increasing the applicability of the system.

This training will be described in more detail below.

After training, the encoder neural network 140 can be discarded or used for some other purpose, e.g., to estimate poses of new images of the scene 125.

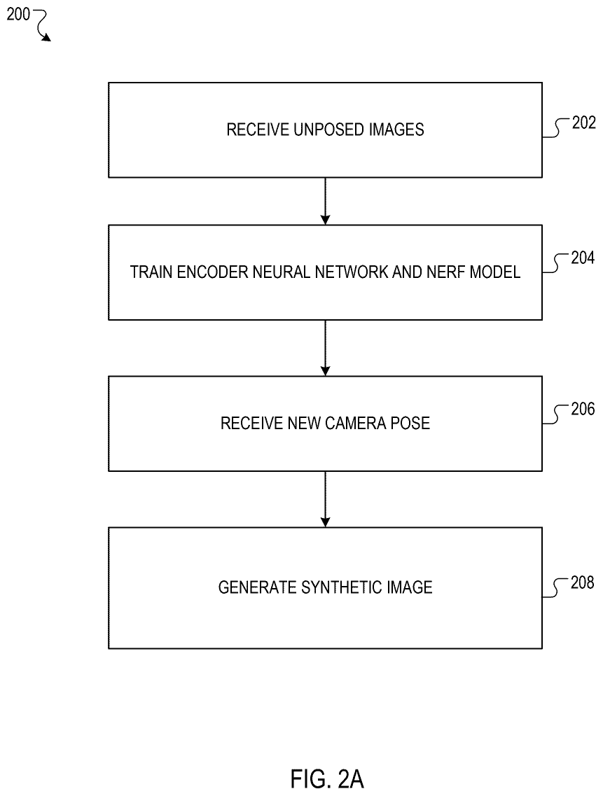

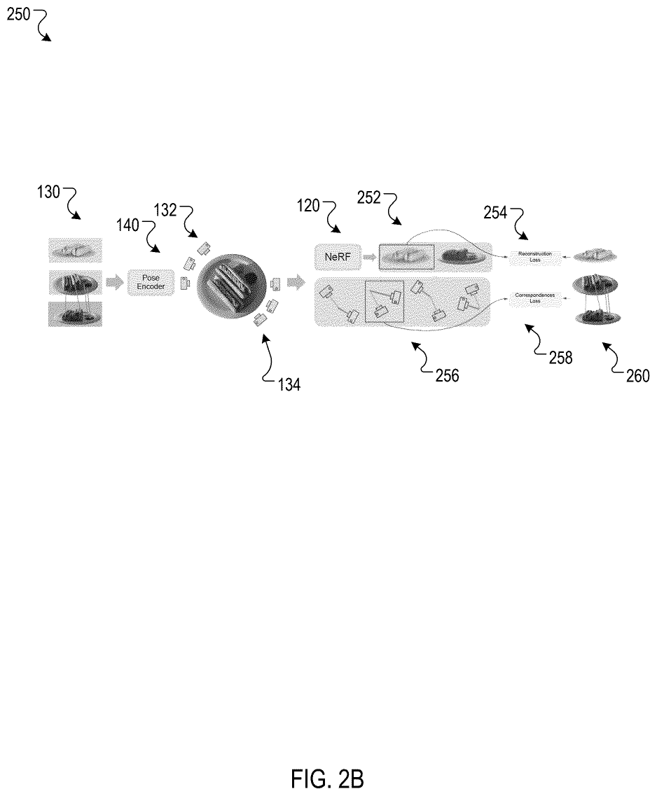

FIG. 2A is a flow diagram of an example process 200 for training a NeRF model on unposed images. For convenience, the process 200 will be described as being performed by a system of one or more computers located in one or more locations. For example, an image rendering system, e.g., the system 100 in FIG. 1, appropriately programmed in accordance with this specification, can perform the process 200.

In particular, to train the NeRF model, the system obtains a plurality of images of a scene in an environment (step 202). As described above, the images are unposed, i.e., the system does not have access to (or for another reason does not use) the camera pose of the camera that captured any of the images.

The system trains, using the plurality of images, (i) an encoder neural network configured to receive an input image and generate, as output, a pose estimate that estimates a camera pose of a camera that captured the input image and (ii) a NeRF model that receives as input the pose estimate generated by the encoder neural network and generates a reconstruction of the input image (step 204). That is, the system jointly trains the encoder and the NeRF model on the unposed images.

For example, the system can repeatedly perform training steps to jointly train the encoder and the NeRF model.

Generally, during the joint training, the system makes use of an equivalence relation to map pose estimates generated by the encoder neural network to larger equivalences classes of pose estimates.

In particular, pose estimation can be a difficult problem because real-life objects can be invariant or almost invariant under certain transformations. This makes the photometric distance between rendered views non-convex with respect to the camera pose and results in the occurrence of local minima in the camera pose space. To account for this and to prevent this from disrupting the joint training, the system can make use of an equivalence relation that matches the distribution of local minima in camera pose space, reducing pose estimation into a more convex problem.

For example, the equivalence relation can map a given camera pose to the set of other camera poses that represent transformations of the camera pose to which objects in the scene are almost invariant. That is, the equivalence relation can map any given camera pose to an equivalence class that includes each equivalent pose estimate for the given camera pose.

In general, the equivalence relation can be based on properties of the scene. As a particular example, the equivalence relation is based on respective symmetries of one or more objects in the scene. That is, the system can determine the equivalence relation based on symmetries of the one or more objects that result in images of the object(s) appearing equivalent or almost equivalent from various camera poses, i.e., can determine the equivalence relation based on the symmetries such that within each equivalence class the symmetries result in images of the scene from each pose within the equivalence class having similar appearance.

As a particular example, an equivalence pose estimate for a given pose estimate can be any pose estimate for which, for any integer k, the equivalent pose estimate is equal to a sum of the given pose estimate and 2kπ/N. Generally, the value of N defines the number of distinct elements of the equivalence class. For example, the value of N can be received as input by the system.

For example, when the camera pose is represented as a tuple that includes, where θ is the camera azimuth, ϕ is the camera elevation, and a is the camera roll, the equivalence for the camera pose (θ, ϕ, α) can include the poses:

$$( θ + 2 k π / N , ϕ , α ) , for k = 1 , 2 , … , N$$

Thus, in this example, the equivalence relation induces a replication of cameras along the azimuthal dimension. Similar relations that replicate across the azimuthal dimension while keeping other parameters fixed can be applied to other pose representations, e.g., to the representation of the camera pose as a combination of azimuth, elevation, radial distance from the origin, and in-plane offset

To leverage the equivalence class for the training, the system generates respective reconstructions using each of the camera poses, i.e., by providing each camera pose in the equivalence class as input to the NeRF model.

The system then uses all of the reconstructions, rather than only the reconstruction for the original pose estimate generated by the encoder neural network, in determining how to evaluate the loss function that is used for training the NeRF model and the encoder neural network.

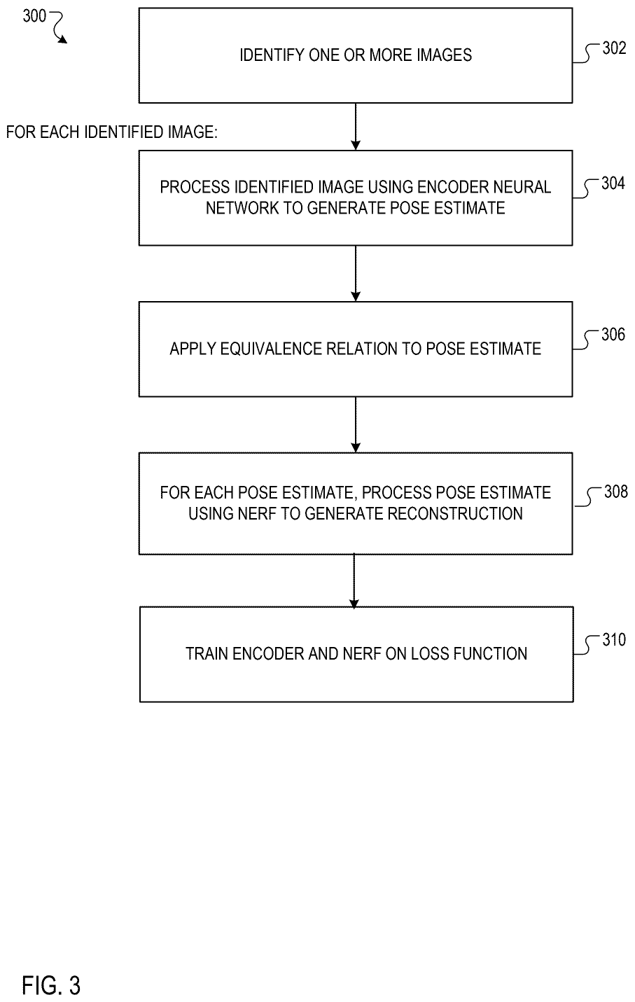

Performing a training step is described in more detail below with reference to FIG. 3.

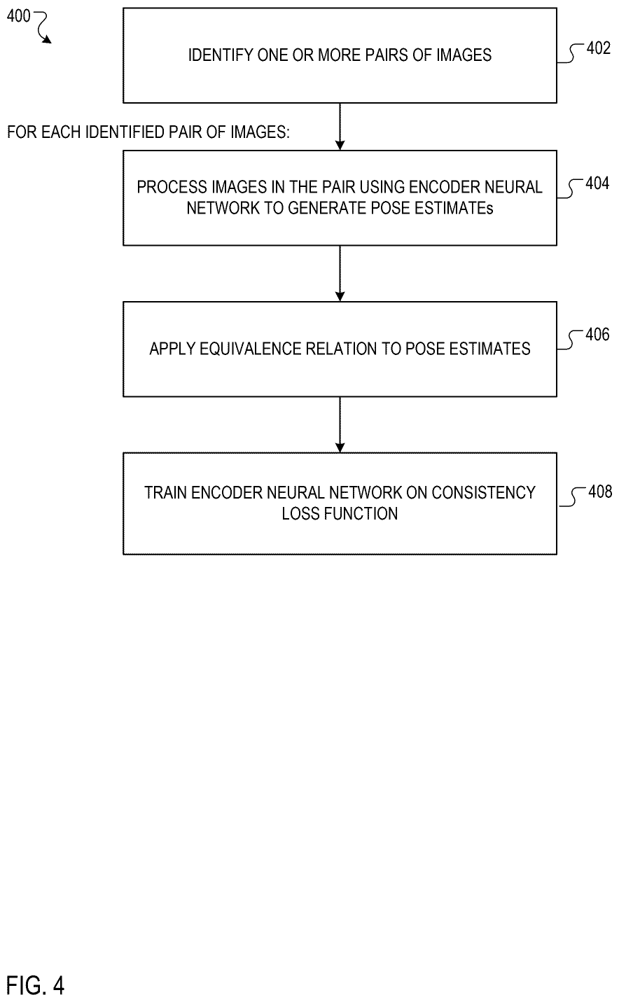

The system also uses equivalence classes when computing the consistency loss, as will be described below with reference to FIGS. 3 and 4.

After training, the system can receive a new camera pose (step 206).

The system can process the new camera pose using the trained NeRF model to generate a new image of the scene that appears as if it was taken by a camera having the new camera pose (step 208). That is, the system can effectively generate new images from new camera poses despite not having any access to camera poses during training of the NeRF model.

As indicated above, in some implementations, the system discards the encoder neural network after training the NeRF model.

In some other implementations, the system can use the encoder neural network after training to estimate the pose of new images of the scene, e.g., for use in downstream applications. That is, after training, the system can receive a new image of the scene and process the new image of the scene using the trained encoder neural network to generate an estimate of a camera pose of a camera that captured the new image.

FIG. 2B shows an example 250 of the operation of the system during training.

During training, the system uses the encoder neural network 140 to process the unposed images 130 to generate camera poses 132 for the unposed images.

For a given unposed image 130, the system generates an equivalence class of camera poses that includes the camera pose 132 predicted by the neural network 140 and an additional camera pose 134 that is generated by applying the equivalence relation to the camera pose 132.

The system renders a respective image from each of the camera poses 132 and 134 with the NeRF model 120 and uses both rendered images, instead of only the image rendered from the camera pose 132, in computing a reconstruction loss 254 for training the NeRF model 120.

In some examples, a plurality of additional camera poses 134 are generated by applying the equivalence relation to the camera pose 132, and a respective image from each of the camera poses 132 and 134 is rendered with the NeRF model 120. The respective images are used in determining the reconstruction loss 254 for training the NeRF model 120.

In order to improve the performance of the training further, the system also incorporates a consistency loss 258 for training the encoder neural network 140. The consistency loss 258 measures geometric consistency between predicted poses 256 for pairs of images. For example, the geometric consistency can be measures of deviations from epipolar geometries, i.e., generated from features of corresponding pairs of images 260, defined by pairs of pose estimates 256 for different images.

Training using the consistency loss 258 will be described in more detail below.

FIG. 3 is a flow diagram of an example process 300 for performing a training step during the joint training of the NeRF model and the encoder neural network. For convenience, the process 300 will be described as being performed by a system of one or more computers located in one or more locations. For example, an image rendering system, e.g., the system 100 in FIG. 1, appropriately programmed in accordance with this specification, can perform the process 300.

The system identifies one or more of the plurality of images (step 302). For example, the system can sample a batch of a fixed number of images from the set.

The system can then perform steps 304-308 for each of the one or more identified images.

The system processes the identified image using the encoder neural network to generate a pose estimate for the identified image (step 304).

The system applies an equivalence relation to the pose estimate for the identified image to generate an equivalence class of a plurality of pose estimates (step 306). That is, the system generates a plurality of pose estimates that belong to the same equivalence class as the pose estimate for the identified image.

As described above, the equivalence relation map a given camera pose to an equivalence class that includes the given camera pose and the set of one or more other camera poses that represent transformations of the camera pose to which objects in the scene are almost invariant. That is, the equivalence relation can map any given camera pose to an equivalence class that includes each equivalent pose estimate for the given camera pose.

As described above, when the camera pose is represented as a tuple (θ, ϕ, α), where θ is the camera azimuth, ϕ is the camera elevation, and a is the camera roll, the equivalence for the camera pose (θ, ϕ, α) can include the poses:

$$( θ + 2 k π / N , ϕ , α ) , for k = 1 , 2 , … , N$$

Thus, in this example, the equivalence relation induces a replication of cameras along the azimuthal dimension.

For each of the plurality of pose estimates in the equivalence class, the system processes the pose estimate using the NeRF model to generate a respective reconstruction of the identified image (step 308). That is, although the input image has only a single corresponding actual (but unknown) pose, the system generates multiple different reconstructions of the input image, each with a different corresponding camera pose.

That is, the NeRF model generates respective reconstructions for each of multiple pose estimates that are in the equivalence class of the original pose estimate predicted by the encoder neural network.

The system trains the encoder neural network and the NeRF model on a loss function (step 310).

In particular, the loss function measures, for each of the plurality of pose estimates for each of the one or more images, an error between the image and the respective reconstruction of the image generated from the pose estimate.

As a particular example, the loss function can measure, for a given identified image and a given pose estimate, a squared L2 error between the given identified image and the respective reconstruction of the given identified image generated using the given pose estimate. Other reconstruction loss functions may alternatively be used.

That is, the system trains the NeRF model and the encoder neural network jointly by determining, through backpropagation, a gradient of the loss function with respect to the parameters of the NeRF model and the parameters of the encoder neural network.

The system can then update the parameters of the NeRF model and the encoder neural network by updating the parameters using the respective gradients, e.g., by applying an appropriate optimizer to the gradients and the current values of the parameters. Examples of appropriate optimizers can include Adam, AdamW, Adafactor, rmsProp, and SGD.

As a particular example, the loss function can measure, for each of the images, the minimum of the errors for each of the plurality of pose estimates for the image.

In particular, in this example, the loss function can satisfy, for a given set that includes n images I:

$${\sum }_{i = 1}^{n} min \{ {‖ C - {I}_{i} ‖}_{2}^{2} , C ∈ {ℭ}_{i}^{ℛ} ( {ψ}_{i} , ξ ) \} ,$$

where

$${ℭ}_{i}^{R} ( ψ , ξ ) = \{ C ( . ; {f}_{ψ} , z ) , z ∈ {[ {h}_{ξ} ( {I}_{i} ) ]}_{ℛ} , C ( . ; {f}_{ψ} , z )$$

is an image generated by the NeRF model using the one or more neural networks f_{ψ} having parameters ψ and given an input camera pose z, and [h_{ξ}(Iᵢ) [symbol] is the equivalence class generated by applying the equivalence relation [symbol] to the estimated camera pose h_{ξ}(Iᵢ) generated by processing the image Iᵢ using the encoder neural network h_{ξ} having parameters ξ.

Thus, in this example, for each image, only gradients of the reconstruction generated using the pose estimate from the equivalence class that resulted in the smallest error will be backpropagated to update the parameters of the encoder neural network.

By making use of this loss, i.e., by backpropagating only gradients of the reconstruction generated using the pose estimate from the equivalence class that resulted in the smallest error, the system only penalizes the encoder neural network if all of the reconstructions from all of the camera poses in the equivalence class are inaccurate. This modification makes the training of the encoder neural network more convex and allows for high quality joint training.

While the above describes that entire images are reconstructed for ease of description, in some implementations, the system can instead reconstruct only a subset of the pixels in each of the images, e.g., one or more randomly selected pixels from each of the images. The system can use the same loss functions described above when performing the training in this manner, with the loss only being applied to the subsets of pixels generated for each of the camera poses rather than to the entire image.

In order to improve the performance of the training further, the system also incorporates a consistency loss for training the encoder neural network. The consistency loss measures geometric consistency between predicted poses for pairs of images. For example, the geometric consistency can be measures of deviations from epipolar geometries defined by pairs of pose estimates for different images.

In particular, the system can compute the geometric consistency using feature correspondences between pairs of training images.

The features can generally be any appropriate features of the training images.

As a particular example, the features can be features of keypoints that have been identified in the training images.

As a particular example, the system can determine, e.g., prior to training as a pre-processing step for all of the training images or incrementally as training progresses, respective features for each of a plurality of keypoints in each of the training images. The system can do this in any of a variety of ways.

As one example, the system can extract respective Scale-Invariant Feature Transform (SIFT) features for each of the training images. SIFT is a technique that extracts, from a given image, a set of keypoints and a respective descriptor feature for each of the keypoints.

As one example, the SIFT features can be RootSIFT features. RootSIFT is a variant of SIFT that modifies descriptor normalization. That is, in RootSIFT, the 12-normalized descriptor is first 11-normalized and then the square root of each element is computed. The resulting description is then 12-normalized. RootSIFT features are described in more detail in Arandjelović, Relja; Zisserman, Andrew (2012). “Three things everyone should know to improve object retrieval”. 2012 IEEE Conference on Computer Vision and Pattern Recognition. pp. 2911-2918. doi: 10.1109/CVPR.2012.6248018.

For each of multiple pairs of images, the system can then determine matches between the keypoints in the two images using the features for each of the keypoints, i.e., can identify, for each of one or more keypoints in one image in the pair, a matching keypoint in the other image in the pair.

As one example, the system can first compute, for each keypoint in the first image in the pair, a feature-space nearest neighbor for the keypoint from the features of the keypoints in the other image in the pair. This forms an initial set of matches, with each keypoint in the first image being matched with the keypoint that corresponds to the feature-space nearest neighbor (among the features of the keypoints in the image in the pair) of the features of the keypoint in the first image.

The system can then filter the resulting initial set of matches, where filtering refers to removing (i.e., filtering out), one or more matches from the initial set of matches.

As one example, the system can filter out each match that is not mutual, i.e., filter out a match between key point A in image A and key point B in image B if key point A is not also the feature space nearest neighbor of key point B among all of the key points in image A.

As another example, the system can filter out matches that do not satisfy Lowe's ratio test.

As yet another example, the system can filter matches with RANSAC, i.e., by finding a fundamental matrix that permits the most inliers.

Optionally, if, after the filtering, a given pair of images does not have at least a threshold number of matches, the system can discard the image pair, i.e., not use the image pair for training.

The system can then store, for each remaining image pair, data identifying the matching key points between the two images in a cache for use during the training.

Training using the consistency loss is described in more detail below with reference to FIG. 4.

FIG. 4 is a flow diagram of an example process 400 for training the encoder neural network using a consistency loss. For convenience, the process 400 will be described as being performed by a system of one or more computers located in one or more locations. For example, an image rendering system, e.g., the system 100 in FIG. 1, appropriately programmed in accordance with this specification, can perform the process 400.

For example, the system can perform the process 400 when performing each training step during the joint training of the NeRF model and the encoder neural network. That is, the encoder neural network can be trained using both the reconstruction loss and the consistency loss at each of the training steps. As a particular example, the update for each parameter of the encoder neural network can be a combination, e.g., a sum or a weighted sum, of the update determined from the reconstruction loss and the update determined from the consistency loss.

The system identifies one or more pairs of images of the scene, i.e., from the set of training images being used for the training (step 402).

For example, the system can identify all of the images that have matches stored in the cache or can identify a random subset of the images that have matches stored in the cache.

The system then performs steps 404 and 406 for each pair.

For each image in the pair, the system processes the image using the encoder neural network to generate a respective pose estimate for the image (step 404). This can be done as described above.

For each image in the pair, the system applies an equivalence relation to the respective pose estimate for the image to generate an equivalence class of a plurality of pose estimates for the image (step 406). This can be done as described above.

Thus, as a result of performing steps 404 and 406 for each pair, the system has obtained, for each image in each pair of images, an equivalence class of a plurality of pose estimates for the image.

The system trains the encoder neural network on a consistency loss function that measures, for each of the one or more pairs of images, geometric consistency between the equivalence classes of pose estimates for the images in the pair (step 408).

As a particular example, the correspondence loss can measure, for each of the pairs, deviations from an epipolar geometry between the images in the pair that are defined by the equivalence classes of pose estimates for the images in the pair.

Generally, the deviation is a disparity between projected keypoints in the image pair computed according to the combination of pose estimates.

One example of such a disparity is the symmetric epipolar distance between the projected keypoints.

The symmetric epipolar distance between a pair of matching keypoints xᵢ and xᵢ from a pair of images i and j given respective poses Rᵢ and Rⱼ for the images i and j can be expressed as:

$$D ( {R}_{i} , {R}_{j} ) = \frac{{x}_{i} \cdot {F}_{ij} {x}_{j}}{\sqrt{{( {x}_{i}^{x} {f}_{11} + {x}_{i}^{y} {f}_{21} + {f}_{31} )}^{2} + {( {x}_{i}^{x} {f}_{12} + {x}_{i}^{y} {f}_{22} + {f}_{32} )}^{2}}} + \frac{{x}_{j} \cdot {F}_{ij}^{T} {x}_{i}}{\sqrt{{( {x}_{j}^{x} {f}_{11} + {x}_{j}^{y} {f}_{12} + {f}_{13} )}^{2} + {( {x}_{i}^{x} {f}_{21} + {x}_{i}^{y} {f}_{22} + {f}_{23} )}^{2}}}$$

where Fᵢⱼ is the fundamental matrix from pose Rᵢ to Rⱼ, fᵢⱼ is the ith row and jth column element in Fᵢⱼ, and xᵢ^{x} and

$${x}_{i}^{y}$$

are the x and y component in xᵢ.

In this example, the deviation for a given pair of pose estimates, can be based on the symmetric epipolar distances (the distances D described above) between the matching keypoints for the pair of images. For example, the deviation can be the sum or the average of the distances for the matching keypoints in the pair of images.

For example, for each of the pairs, the consistency loss function can measure a deviation for a pair of pose estimates that results in the minimum deviation of any combination of pose estimates from the equivalence classes for the images of the pair. That is, for a given pair of images, the reconstruction loss can measure, from among the possible combinations of camera poses from the equivalence classes for the images of the pair, only the minimum deviation for any pair of pose estimates. For example, the loss can be equal to the minimum deviation divided by the total number of matching key points between the pair of images.

In some cases, when the system uses multiple image pairs at each training step, the system can filter out certain ones of the image pairs to avoid outliers with large epipolar errors from contributing to the training process. As a particular example of this, the system can use only the image pairs with the K smallest losses in the loss function:

$${ℒ}_{corr} = \frac{1}{K} {\sum }_{i = 1}^{K} {min}_{i} \{ {ℒ}_{pair}^{1} , … , {ℒ}_{pair}^{\vert Q \vert} \} .$$

where |Q| is the total number image pairs at the training step and Lpair is the consistency loss for the corresponding pair of images.

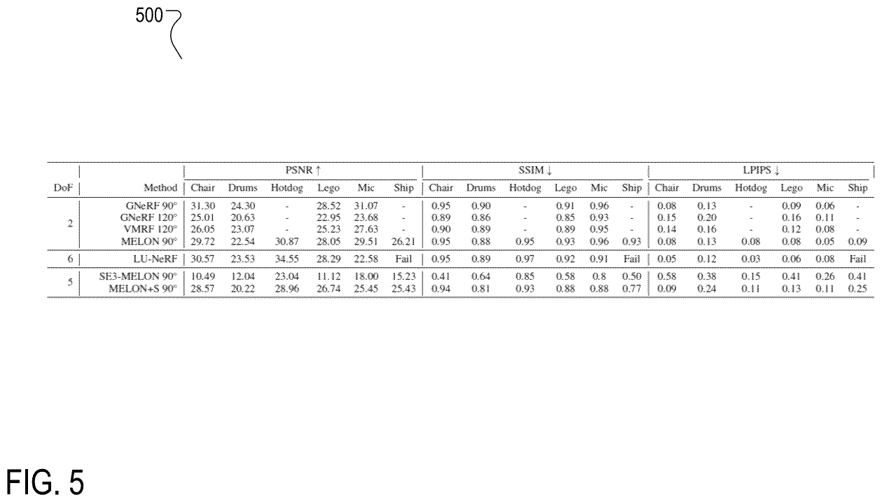

FIG. 5 shows an example 500 of the performance of the described system.

In particular, the example 500 shows the performance of the described system (“MELON+S”) for six different scenes with different types objects on novel view synthesis.

The performance is described in terms of Peak Signal Noise Ratio (PSNR), Structural Similarity Index Measure (SSIM), and Learned Perceptual Image Patch Similarity (LPIPS), across a corresponding test set.

As can be seen from the example, MELON+S successfully learns each of the scenes even with complex 5 DoF camera poses. That is, even though MELON+S is generating pose estimates with five degrees of freedom, it is competitive with techniques that can only predict poses with 2 degrees of freedom and can successfully learn each of the scenes, unlike the LU-NeRF technique.

As described, the system can use any of a variety of NeRF variants as the NeRF model 120.

Examples of NeRF variants include those described in Mildenhall, et al, NeRF: Representing Scenes as Neural Radiance Fields for View Synthesis, available at arXiv: 2003.08934; J. T. Barron, B. Mildenhall, D. Verbin, P. P. Srinivasan, and P. Hedman, “Mip-nerf 360: Unbounded anti-aliased neural radiance fields,” CoRR, vol. abs/2111.12077, 2021; T. Muller, A. Evans, C. Schied, and A. Keller, “Instant neural graphics primitives with a multiresolution hash encoding,” ACM Trans. Graph., vol. 41, pp. 102:1-102:15, July 2022; D. Verbin, P. Hedman, B. Mildenhall, T. E. Zickler, J. T. Barron, and P. P. Srinivasan, “Ref-nerf: Structured view-dependent appearance for neural radiance fields,” CoRR, vol. abs/2112.03907, 2021; J. T. Barron, B. Mildenhall, M. Tancik, P. Hedman, R. Martin-Brualla, and P. P. Srinivasan, “Mip-nerf: A multiscale representation for antialiasing neural radiance fields,” CoRR, vol. abs/2103.13415, 2021.

An example of one variant of the NeRF model 120 now follows.

In the example, the model 120 includes a first neural network and a second neural network.

The first neural network (f_{σ}) is configured to receive a first input that includes data representing coordinates of a point x in the scene and to process the first input to generate an output that includes (i) a volume density σ for the point x and (ii) a feature vector. For example, the first neural network can be a multi-layer perceptron (MLP) that processes the coordinates x to generate the output.

As a particular example, the point in the scene can be represented as, e.g., a three-dimensional vector of spatial coordinates x.

Generally, the volume density at a point in the scene can characterize any appropriate aspect of the scene at the point. In one example, the volume density at a point in the scene can characterize a likelihood that a ray of light travelling through the scene would terminate at the point x in the scene.

In particular, the model 120 can be configured such that the volume density σ is generated independently from the viewing direction d, and thus varies only as a function of points in the scene. This can encourage volumetric consistency across different viewing perspectives of the same scene.

In some cases, the volume density can have values, e.g., σ≥0, where the value of zero can represent, e.g., a negligible likelihood that a ray of light would terminate at a particular point, e.g., possibly indicating that there are no objects in the scene at that point. On the other hand, a large positive value of volume density can possibly indicate that there is an object in the scene at that point and therefore there is a high likelihood that a ray would terminate at that location.

The second neural network (f_{c}) is configured to receive an input that includes the feature vector (generated by the first neural network) and data representing a viewing direction d and process the second input to generate as output a color. For example, the second neural network 350 also be an MLP that processes the feature vector d to generate as output the color.

The color generated as output by the second neural network for a given viewing direction d and point x is the radiance emitted in that viewing direction at that point in the scene, e.g., RGB, where R is the emitted red color, G is the emitted green color, and B is the emitted blue color.

Optionally, the “second” input to the second neural network can also include additional information, e.g., any of appearance embeddings, target exposure information, and so on.

An example of how the model 120 that has these two neural networks uses the neural networks to render an image is described in more detail in Mildenhall, et al, NeRF: Representing Scenes as Neural Radiance Fields for View Synthesis, available at arXiv: 2003.08934.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining a plurality of images of a scene in an environment; and
training, using the plurality of images, (i) an encoder neural network configured to receive an input image and generate, as output, a pose estimate that estimates a camera pose of a camera that captured the input image and (ii) a neural radiance field (NeRF) model that receives as input the pose estimate generated by the encoder neural network and generates a reconstruction of the input image, the training comprising, at each of a plurality of training iterations:
for each of one or more pairs of images of the scene:
for each image in the pair, processing the image using the encoder neural network to generate a respective pose estimate for the image; and
for each image in the pair, applying an equivalence relation to the respective pose estimate for the image to generate an equivalence class of a plurality of pose estimates for the image; and
training the encoder neural network on a consistency loss function that measures, for each of the one or more pairs of images, geometric consistency between the equivalence classes of pose estimates for the images in the pair.

2. The method of claim 1, wherein the correspondence loss measures, for each of the pairs, deviations from an epipolar geometry between the images in the pair that are defined by the equivalence classes of pose estimates for the images in the pair.

3. The method of claim 1, wherein, for each of the pairs, the reconstruction loss function measures a deviation for a pair of pose estimates that results in a minimum deviation of any combination of pose estimates from the equivalence classes for the images of the pair.

4. The method of claim 3, wherein, for each combination of pose estimates from the equivalence classes, the deviation is a disparity between projected keypoints in the image pair computed according to the combination of pose estimates.

5. The method of claim 4, wherein the disparity is a symmetric epipolar distance.

6. The method of claim 4, wherein correspondences between projected keypoints are based on Scale-Invariant Feature Transform (SIFT) features of the images in the image pair.

7. The method of claim 6, wherein the SIFT features are RootSIFT features.

8. The method of claim 6, wherein pairs of images that do not have at least a threshold number of corresponding keypoints are not included in the one or more pairs of images.

9. The method of claim 1, further comprising maintaining a queue of image pairs and wherein the one or more image pairs are the one or more image pairs in the queue having the smallest geometric consistency losses.

10. The method of claim 9, wherein the image pairs in the queue are randomly selected from possible pairs that each include two of the images of the scene.

11. The method of claim 1, further comprising, at each of the plurality of training iterations:
for each image in a set of one or more of the plurality of images:
processing the image using the encoder neural network to generate a pose estimate for the image;
applying the equivalence relation to the pose estimate to generate an equivalence class of a plurality of pose estimates; and
for each of the plurality of pose estimates, processing the pose estimate using the NeRF model to generate a respective reconstruction of one or more pixels from the image; and
training the encoder neural network and the NeRF model on a reconstruction loss function that measures, for each of the plurality of pose estimates for each of the one or more images, an error between the one or more pixels of the image and the respective reconstruction of the one or more pixels of the image generated from the pose estimate.

12. The method of claim 1, further comprising:
after the training, receiving data specifying a new camera pose; and
processing the data specifying the new camera pose using the trained NeRF model to generate a new image of the scene that appears to be taken by a camera having the new camera pose.

13. The method of claim 1, further comprising:
after the training, receiving a new image of the scene; and
processing the new image of the scene using the trained encoder neural network to generate an estimate of a camera pose of a camera that captured the new image.

14. The method of claim 1, wherein the equivalence relation is based on properties of the scene.

15. The method of claim 14, wherein the equivalence relation is based on respective symmetries of one or more objects in the scene.

16. The method of claim 1, wherein the equivalence relation specifies that the equivalence class includes each equivalent pose estimate, and wherein an equivalent pose estimate is any pose estimate for which, for any integer k, the equivalent pose estimate is equal to a sum of the pose estimate and 2kπ/N.

17. The method of claim 16, wherein the value of N is received as input and defines a number of distinct elements of the equivalence class.

18. The method of claim 1, wherein the pose estimate comprises an estimated azimuth of the camera.

19. The method of claim 18, wherein the equivalence relation induces a replication of cameras along the azimuthal dimension.

20. The method of claim 1, wherein the pose estimate comprises an estimated elevation of the camera.

21. The method of claim 1, wherein the pose estimate comprises an estimate camera roll of the camera.

22. The method of claim 1, wherein the pose estimate comprises an estimated location of an origin in a camera reference frame of the camera.

23. The method of claim 1, wherein the encoder neural network is a convolutional neural network.

24. The method of claim 11, wherein the reconstruction loss function measures, for each of the one or more images, a minimum of the errors for each of the plurality of pose estimates for the image.

25. The method of claim 11, wherein the error between the image and the respective reconstruction of the image generated from the pose estimate is a squared L2 error between the image and the respective reconstruction.

26. A system comprising one or more computers and one or more storage devices storing instructions that when executed by the one or more computers cause the one or more computers to perform operations comprising:
obtaining a plurality of images of a scene in an environment; and
training, using the plurality of images, (i) an encoder neural network configured to receive an input image and generate, as output, a pose estimate that estimates a camera pose of a camera that captured the input image and (ii) a neural radiance field (NeRF) model that receives as input the pose estimate generated by the encoder neural network and generates a reconstruction of the input image, the training comprising, at each of a plurality of training iterations:
for each of one or more pairs of images of the scene:
for each image in the pair, processing the image using the encoder neural network to generate a respective pose estimate for the image; and
for each image in the pair, applying an equivalence relation to the respective pose estimate for the image to generate an equivalence class of a plurality of pose estimates for the image; and
training the encoder neural network on a consistency loss function that measures, for each of the one or more pairs of images, geometric consistency between the equivalence classes of pose estimates for the images in the pair.

27. One or more non-transitory computer storage media storing instructions that when executed by one or more computers cause the one or more computers to perform operations comprising:
obtaining a plurality of images of a scene in an environment; and
training, using the plurality of images, (i) an encoder neural network configured to receive an input image and generate, as output, a pose estimate that estimates a camera pose of a camera that captured the input image and (ii) a neural radiance field (NeRF) model that receives as input the pose estimate generated by the encoder neural network and generates a reconstruction of the input image, the training comprising, at each of a plurality of training iterations:
for each of one or more pairs of images of the scene:
for each image in the pair, processing the image using the encoder neural network to generate a respective pose estimate for the image; and
for each image in the pair, applying an equivalence relation to the respective pose estimate for the image to generate an equivalence class of a plurality of pose estimates for the image; and
training the encoder neural network on a consistency loss function that measures, for each of the one or more pairs of images, geometric consistency between the equivalence classes of pose estimates for the images in the pair.
